(19) United States
(12) Patent Application Publication
(10) Pub. No.: US 2026/0330511 A1
(43) Pub. Date: Oct. 22, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Kazuhiro HAYASHI, Tokyo (JP)

(21) Appl. No.: 19/558,113

(22) Filed: Mar. 5, 2026

(30) Foreign Application Priority Data
Apr. 17, 2025 (JP) 2025-068244

(51) Int. Cl. G06Q 30/0241; G06F 40/134

(52) U.S. Cl. CPC G06Q 30/0276; G06F 40/134; G06Q 30/0249

(57) ABSTRACT

An information processing apparatus according to the present application includes a collection unit, a generation unit, a distribution unit, and a determination unit. The collection unit collects a plurality of pieces of first distribution content each including content related to a predetermined event or object. The generation unit generates the content related to the predetermined event or object based on the plurality of pieces of first distribution content collected by the collection unit. The distribution unit distributes, to a user, second distribution content including the content generated by the generation unit and respective links to the plurality of pieces of first distribution content. The determination unit determines a consideration to be paid by a distributor of each of the plurality of pieces of first distribution content, based on a selection result by the user for the links included in the second distribution content distributed by the distribution unit.

### CROSS-REFERENCE TO RELATED APPLICATIONS

The present application claims priority to and incorporates by reference the entire contents of Japanese Patent Application No. 2025-068244 filed in Japan on Apr. 17, 2025.

### BACKGROUND OF THE INVENTION

### 1. Field of the Invention

The present invention relates to an information processing apparatus, an information processing method, and a non-transitory computer readable storage medium.

### 2. Description of the Related Art

In recent years, with the rapid spread of the Internet, content such as a news article has been distributed. For example, regarding the distribution of such content, a technology for providing summarized content obtained by summarizing content such as a news article has been proposed (refer to, for example, JP 6664603 B2).

However, distribution content (for example, a news article or the like) related to the same event or object may be distributed from a plurality of distributors, and it is desirable for a user to be able to easily select desired distribution content from among the plurality of pieces of distribution content distributed from the plurality of distributors.

### SUMMARY OF THE INVENTION

An information processing apparatus according to the present application includes a collection unit, a generation unit, a distribution unit, and a determination unit. The collection unit collects a plurality of pieces of first distribution content each including content related to a predetermined event or object. The generation unit generates the content related to the predetermined event or object based on the plurality of pieces of first distribution content collected by the collection unit. The distribution unit distributes, to a user, second distribution content including the content generated by the generation unit and respective links to the plurality of pieces of first distribution content. The determination unit determines a consideration to be paid by a distributor of each of the plurality of pieces of first distribution content, based on a selection result by the user for the links included in the second distribution content distributed by the distribution unit.

It should be noted that some or all of the above-described means for solving the problem may be implemented using various artificial intelligence-related technologies and techniques, including, but not limited to, the use of various generative AI models implemented using machine learning, deep learning, large language models, and the like.

### BRIEF DESCRIPTION OF THE DRAWINGS

FIG. 1 is a diagram illustrating an example of information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a first distribution content table stored in a content storage unit of the information processing apparatus according to the embodiment;

FIG. 6 is a diagram illustrating an example of a second distribution content table stored in the content storage unit of the information processing apparatus according to the embodiment;

FIGS. 7A to 7C are diagrams illustrating an example of a plurality of pieces of first distribution content according to the embodiment;

FIG. 8 is a diagram illustrating an example of predetermined event content generated by a generation unit in a processing unit of the information processing apparatus according to the embodiment;

FIG. 9 is a diagram illustrating an example of the second distribution content distributed by a distribution unit in the processing unit of the information processing apparatus according to the embodiment;

FIG. 10 is a flowchart illustrating an example of information processing by the processing unit of the information processing apparatus according to the embodiment; and

FIG. 11 is a hardware configuration diagram illustrating an example of a computer that implements a function of the information processing apparatus according to the embodiment.

### DETAILED DESCRIPTION OF THE PREFERRED EMBODIMENTS

Hereinafter, modes (hereinafter referred to as “embodiments”) for implementing an information processing apparatus, an information processing method, and a non-transitory computer readable storage medium according to the present application will be described in detail with reference to the drawings. Note that the information processing apparatus, the information processing method, and the non-transitory computer readable storage medium according to the present application are not limited by these embodiments. In addition, the respective embodiments can be appropriately combined within a range in which the processing contents do not contradict each other. In the following embodiments, the same parts will be denoted by the same reference numerals, and redundant descriptions thereof will be omitted.

### 1. Example of Information Processing

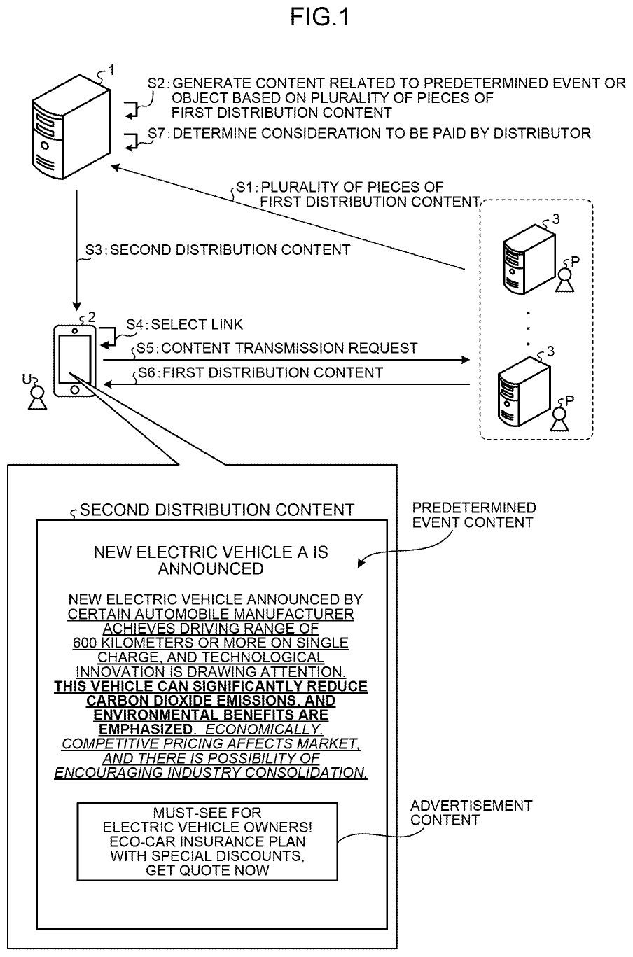

First, an example of information processing according to an embodiment will be described with reference to FIG. 1. FIG. 1 is a diagram illustrating an example of information processing according to an embodiment.

As illustrated in FIG. 1, an information processing apparatus 1 collects a plurality of pieces of first distribution content each including content related to a predetermined event or object (Step S1). The plurality of pieces of first distribution content are, for example, pieces of content provided by different distributors P, and the information processing apparatus 1 collects the plurality of pieces of first distribution content from a plurality of distribution devices 3 that provide the pieces of first distribution content from the different distributors P.

The distributor P is, for example, a medium company (for example, an Internet media) that distributes a news article related to a predetermined event or object as the first distribution content, but is not limited to such an example. In addition, the predetermined event is a specific phenomenon or a specific occurrence, and is, for example, a specific occurrence or incident, or a specific occurrence or incident related to a specific person, but is not limited to such an example. The predetermined object is, for example, a specific person, a specific animal, a specific article, or the like, but is not limited to such an example.

Subsequently, the information processing apparatus 1 generates content related to a predetermined event or object, based on the plurality of pieces of first distribution content collected in Step S1 (Step S2). Hereinafter, content related to a predetermined event or object may be referred to as predetermined event content for convenience.

In Step S2, the information processing apparatus 1 generates predetermined event content by using, for example, generative Artificial Intelligence (AI). The generative AI is, for example, Large Language Models (LLM).

For example, in Step S2, the information processing apparatus 1 generates content including information on each of the plurality of pieces of first distribution content as the predetermined event content by using the generative AI. The information on the first distribution content included in the predetermined event content is, for example, information obtained by summarizing the first distribution content with the generative AI (hereinafter, it may be referred to as summary information).

For example, the information processing apparatus 1 can input information including a plurality of pieces of first distribution content and an instruction sentence that instructs the generation of content including a summary of each of the plurality of pieces of first distribution content to the generative AI as input information, and cause the generative AI to generate the predetermined event content. The instruction sentence is, for example, a character string “Summarize a plurality of pieces of given first distribution content and combine them into a single piece of content. At that time, output information indicating which portion is a summarized portion of each piece of first distribution content separately from the summarized content.”, or the like, but is not limited to such an example.

Subsequently, the information processing apparatus 1 distributes the second distribution content including the predetermined event content generated in Step S2 and respective links to the plurality of pieces of first distribution content to a user U (Step S3). The information processing apparatus 1 can include advertisement content in the second distribution content.

A terminal device 2 of the user U receives the second distribution content transmitted from the information processing apparatus 1, and displays the received second distribution content. In the example illustrated in FIG. 1, the second distribution content includes the predetermined event content, the respective links to the plurality of pieces of first distribution content, the advertisement content, and a link to the advertisement content. The advertisement content included in the second distribution content is, for example, advertisement content related to the predetermined event content, but is not limited to such an example.

In the example illustrated in FIG. 1, the second distribution content is generated from a plurality of pieces of first distribution content which are pieces of news content each having “new electric vehicle A” as a predetermined object. In the second distribution content, “new electric vehicle A is announced” is a title, and pieces of summary information on each of the three pieces of first distribution content are included. In the example illustrated in FIG. 1, these pieces of summary information are illustrated in different manners from each other for convenience of description so that the position of each piece of summary information can be understood. A link (for example, a hyperlink) is attached to each piece of summary information. The link includes a Uniform Resource Locator (URL) of a transition destination.

The user U can select the link attached to the summary information on the first distribution content in a state in which the second distribution content is displayed on the terminal device 2 (Step S4). When the user U selects the link, the terminal device 2 transmits a content transmission request to the distribution device 3 based on the link selected by the user U (Step S5). The distribution device 3, upon receiving the content transmission request, distributes the first distribution content corresponding to the URL included in the content transmission request to the terminal device 2 (Step S6).

The user U can select the advertisement content in a state in which the second distribution content is displayed on the terminal device 2. In a case in which the user U selects the advertisement content, the terminal device 2 acquires a landing page of the advertisement content from an advertisement distribution device based on the link attached to the advertisement content selected by the user U, and displays the acquired landing page.

Although not illustrated in FIG. 1, the second distribution content transmitted from the information processing apparatus 1 is distributed to each of the plurality of terminal devices 2, and the processes of Steps S4 to S6 are performed corresponding to each of the plurality of terminal devices 2.

Subsequently, the information processing apparatus 1 determines a consideration to be paid by each distributor P of the plurality of pieces of first distribution content, based on a result of selection of each user U for the link included in the second distribution content distributed in Step S3 (Step S7).

For example, the information processing apparatus 1 can set an amount according to the number of selections by the user U as the consideration to be paid by the distributor P who distributes the first distribution content of the selected link. The amount according to the number of selections by the user U is, for example, an amount proportional to the number of selections by the user U or an amount that increases stepwise as the number of selections by the user U increases.

In addition, the information processing apparatus 1 can also determine a consideration to be paid to each distributor P of the plurality of pieces of first distribution content, based on a result of selection of the user U for the advertisement content included in the second distribution content. For example, the information processing apparatus 1 can determine an amount obtained by equally dividing a part of the revenue from the distribution of the advertisement content as the consideration to be paid to each distributor P. In addition, the information processing apparatus 1 can determine, as the consideration to be paid to each distributor P, an amount from a part of the revenue from the distribution of the advertisement content, in which the amount becomes a larger amount or a smaller amount as the number of selections by the user U increases.

In addition, in Step S2, the information processing apparatus 1 can also select, as the first distribution content used for generating the predetermined event content, a piece of content corresponding to a link in which a selection result of a link included in the predetermined event content satisfies a predetermined condition (for example, a link whose number of selections is a threshold value or more).

Hereinafter, a configuration and the like of an information processing system including the information processing apparatus 1, the terminal device 2, and the distribution device 3 for performing such processing will be described in detail.

### 2. Configuration of Information Processing System

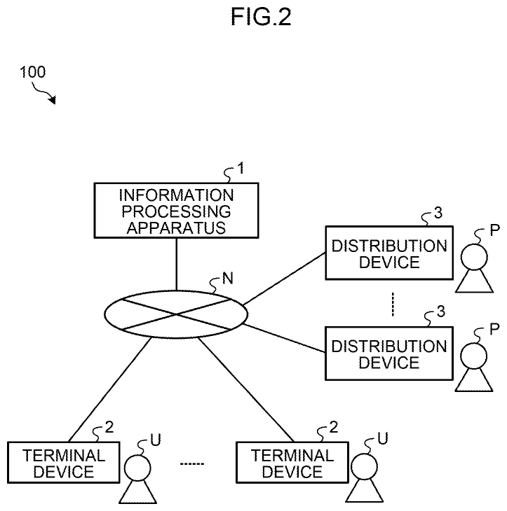

FIG. 2 is a diagram illustrating an example of a configuration of an information processing system according to the embodiment. As illustrated in FIG. 2, an information processing system 100 according to an embodiment includes the information processing apparatus 1, a plurality of terminal devices 2, and a plurality of distribution devices 3.

The plurality of terminal devices 2 are used by different users U. The terminal device 2 is, for example, a notebook Personal Computer (PC), a desktop PC, a smartphone, a tablet PC, or a wearable device. The wearable device is, for example, a smart glass, a smart watch, or the like, but is not limited to such examples.

The plurality of distribution devices 3 are distribution devices that different distributors P have. The distribution device 3 is, for example, a server, but is not limited to such an example. The distributor P is, for example, a media company (for example, an Internet media) that distributes a news article, but is not limited to such an example.

The information processing apparatus 1, the terminal device 2, and the distribution device 3 are connected to each other via a network N so as to be able to communicate with each other in a wired or wireless manner. Note that the information processing system 100 illustrated in FIG. 2 may include a plurality of information processing apparatuses 1 and the like.

The network N includes, for example, a Wide Area Network (WAN) such as the Internet, a mobile communication network such as Long Term Evolution (LTE), 4th Generation (4G), or 5th Generation (5G: 5th Generation Mobile Communication System), and the like but is not limited to such an example.

The terminal device 2 is connected to the network N via short-range wireless communication such as a mobile communication network, Bluetooth (registered trademark), or a wireless Local Area Network (LAN), and can communicate with the information processing apparatus 1 or the like.

### 3. Configuration of Information Processing Apparatus 1

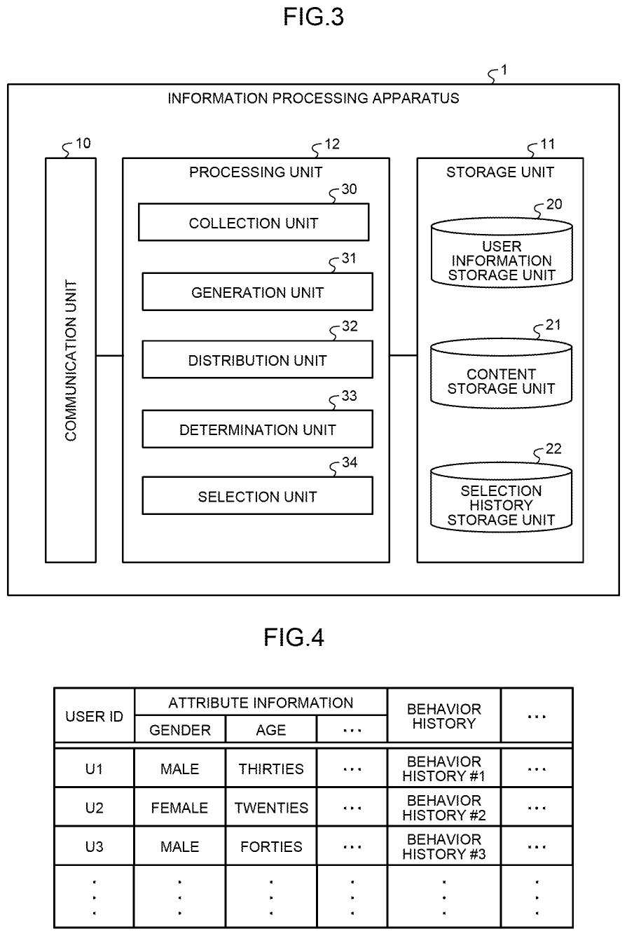

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a Network Interface Card (NIC), or the like. Then, the communication unit 10 is connected to the network N in a wired or wireless manner, and transmits and receives information to and from various other devices. For example, the communication unit 10 transmits and receives information to and from the terminal device 2 and the distribution device 3 via the network N.

### 3.2. Storage Unit 11

The storage unit 11 is implemented by, for example, a semiconductor memory element such as a Random Access Memory (RAM) or a flash memory, or a storage device such as a hard disk or an optical disk. The storage unit 11 includes a user information storage unit 20, a content storage unit 21, and a selection history storage unit 22.

### 3.2.1. User Information Storage Unit 20

The user information storage unit 20 stores user information including information on the user U. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as “user ID,” “attribute information,” and “behavior history”.

The “user ID” is identification information for identifying the user U. The “attribute information” is attribute information on the user U corresponding to the “user ID,” and includes, for example, information on psychographic attributes, information on demographic attributes, and the like. The demographic attributes are, for example, gender, age, place of residence, occupation, and the like, and the psychographic attributes are objects of interest such as travel, clothes, cars, and religion, lifestyle, ideology, ideological trends, and the like.

The “behavior history” is a behavior history of the user U corresponding to the “user ID.” The behavior history of the user U includes, for example, a history of past selections (a click operation, a tap operation, or the like) by the user U of a link included in the second distribution content provided to the user U by the processing unit 12 of the information processing apparatus 1. In addition, the behavior history of the user U also includes information such as, for example, a search history, a browsing history, a posting history, and a purchase history, as the behavior history of the user U in an online service.

### 3.2.2. Content Storage Unit 21

The content storage unit 21 stores various types of content. For example, the content storage unit 21 stores the first distribution content, the second distribution content, and the advertisement content.

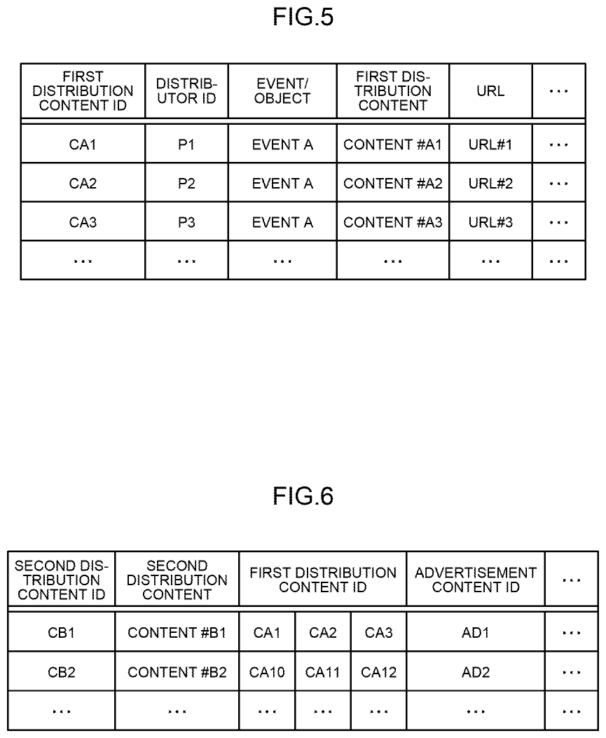

FIG. 5 is a diagram illustrating an example of a first distribution content table stored in the content storage unit 21 of the information processing apparatus 1 according to the embodiment. As illustrated in FIG. 5, the first distribution content table stored in the content storage unit 21 includes items such as “first distribution content ID”, “distributor ID”, “event/object”, “first distribution content”, and “URL”.

The “first distribution content ID” is identification information for identifying the first distribution content. The “distributor ID” is identification information for identifying the distributor P who distributes the first distribution content corresponding to the “first distribution content ID”. The “event/object” is information indicating an event or an object indicated by the first distribution content corresponding to the “first distribution content ID”.

The “first distribution content” is a piece of first distribution content corresponding to the “first distribution content ID”. The “URL” is a URL of the first distribution content corresponding to the “first distribution content ID”.

FIG. 6 is a diagram illustrating an example of a second distribution content table stored in the content storage unit 21 of the information processing apparatus 1 according to the embodiment. As illustrated in FIG. 6, the second distribution content table stored in the content storage unit 21 includes items such as “second distribution content ID”, “second distribution content”, “first distribution content ID”, and “advertisement content ID”.

The “second distribution content ID” is identification information for identifying the second distribution content. The “second distribution content” is a piece of second distribution content corresponding to the “second distribution content ID”. The “first distribution content ID” is the first distribution content ID of the first distribution content whose information is included in the second distribution content corresponding to the “second distribution content ID”. The “advertisement content ID” is identification information for identifying the advertisement content whose information is included in the second distribution content corresponding to the “second distribution content ID”.

Note that, although not illustrated, the content storage unit 21 stores a partial information table in which partial information on the first distribution content and the first distribution content ID are associated with each other for each piece of first distribution content. The partial information is summary information or excerpt information, but is not limited to such an example.

### 3.2.3. Selection History Storage Unit 22

The selection history storage unit 22 stores a selection history, which is a history of selections by the user U of a link included in the second distribution content.

The selection history includes, for example, for each selection by the user U, the first distribution content ID of the first distribution content to which the link selected by the user U is attached, the second distribution content ID of the second distribution content including information on the first distribution content to which the link selected by the user U is attached, information on the date and time when the link is selected by the user U, the user ID of the user U, and the like.

### 3.3. Processing Unit 12

The processing unit 12 is a controller and is implemented by, for example, a processor such as a Central Processing Unit (CPU) or a Micro Processing Unit (MPU) executing various programs (corresponding to an example of an information processing program) stored in a storage device inside the information processing apparatus 1 using a RAM or the like as a work area.

Furthermore, the processing unit 12 is a controller, and for example, a part or all of the processing unit 12 may be implemented by an integrated circuit such as an Application Specific Integrated Circuit (ASIC), a Field Programmable Gate Array (FPGA), or a General Purpose Graphic Processing Unit (GPGPU).

As illustrated in FIG. 3, the processing unit 12 includes a collection unit 30, a generation unit 31, a distribution unit 32, a determination unit 33, and a selection unit 34, and implements or executes a function and an action of information processing described below. Note that the internal configuration of the processing unit 12 is not limited to the configuration illustrated in FIG. 3, and may be another configuration as long as the configuration performs information processing to be described later.

### 3.3.1. Collection Unit 30

The collection unit 30 collects various types of information. For example, the collection unit 30 collects content from an external device such as the distribution device 3 via the communication unit 10.

For example, the collection unit 30 collects a plurality of pieces of first distribution content each including content related to a predetermined event or object from the plurality of distribution devices 3. The plurality of pieces of first distribution content related to a predetermined event or object are pieces of content related to the same event or object, but may be pieces of content related to mutually related events or objects.

Note that the collection unit 30 may also collect, from a single distribution device 3, a plurality of pieces of first distribution content each including content related to a predetermined event or object. The first distribution content is a news article, but may be blog content, posted content, or the like, or may be a comment on the piece of content.

The predetermined event is a specific phenomenon or a specific occurrence, for example, a specific occurrence or incident, or a specific occurrence or incident related to a specific person or the like, but is not limited to such an example. For example, the predetermined event may be a specific event, a specific abnormal weather, a specific natural disaster, or the like. Additionally, the predetermined object is, for example, a specific person, a specific animal, a specific item, or the like, but is not limited to such an example.

### 3.3.2. Generation Unit 31

The generation unit 31 generates various types of information and content. The generation unit 31 generates, for example, predetermined event content which is a piece of content related to a predetermined event or object, based on a plurality of pieces of first distribution content collected by the collection unit 30. The predetermined event content includes, for example, a title related to a predetermined event or object and an explanatory sentence thereof.

The generation unit 31 generates the predetermined event content using, for example, the generative AI. The generative AI is, for example, an LLM, and the LLM is a multimodal LLM, but is not limited to such an example.

For example, the generation unit 31 generates, by using the generative AI, the content including information on each of the plurality of pieces of first distribution content as the content related to the predetermined event or object. The information on the first distribution content included in the predetermined event content is, for example, summary information which is information obtained by summarizing the first distribution content by the generative AI, but may be information obtained by excerpting a part of the first distribution content by the generative AI.

The generation unit 31 can input, into the generative AI as input information, information including, for example, a plurality of pieces of first distribution content and an instruction sentence that instructs the generation of content including a summary of each of the plurality of pieces of first distribution content, and can cause the generative AI to generate the predetermined event content. The instruction sentence is, for example, a character string “Summarize a plurality of pieces of given first distribution content and combine them into a single piece of content. At that time, output information indicating which portion is a summarized portion of each piece of first distribution content separately from the summarized content.”, or the like, but is not limited to such an example.

In addition, in a case in which part of the information is excerpted from the first distribution content by the generative AI, the instruction sentence is, for example, a character string “Please excerpt points to be noted from each of the plurality of pieces of given first distribution content and combine them into one piece of content. At that time, please output information indicating which portion is the excerpted portion from each piece of the first distribution content separately from the summarized content.”, but is not limited to such an example.

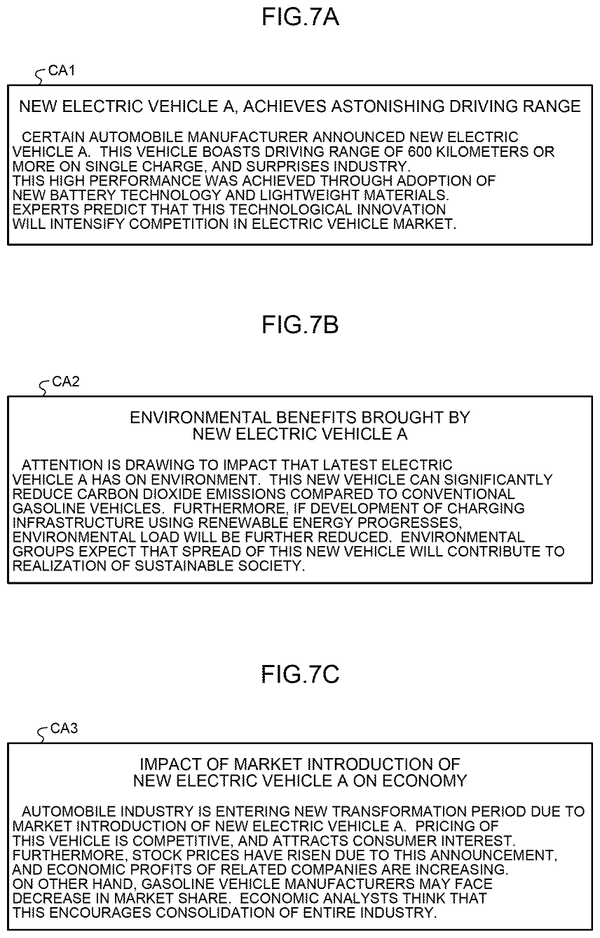

FIGS. 7A to 7C are diagrams illustrating an example of a plurality of pieces of first distribution content according to the embodiment. In the example illustrated in FIGS. 7A to 7C, the plurality of pieces of first distribution content are three pieces of content including first distribution content CA1 illustrated in FIG. 7A, first distribution content CA2 illustrated in FIG. 7B, and first distribution content CA3 illustrated in FIG. 7C.

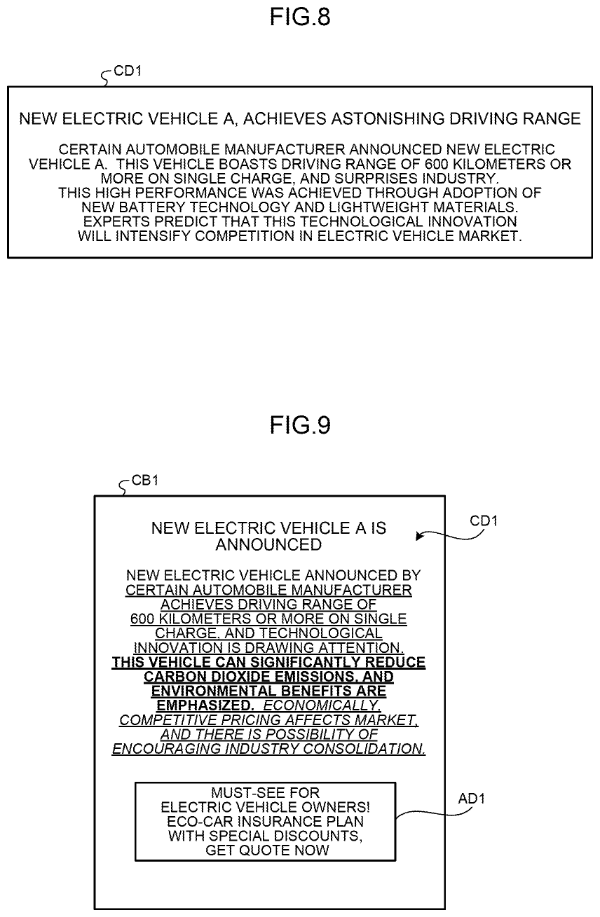

FIG. 8 is a diagram illustrating an example of predetermined event content generated by the generation unit 31 in the processing unit 12 of the information processing apparatus 1 according to the embodiment. Predetermined event content CD1 illustrated in FIG. 8 includes information on each of the three pieces of first distribution content CA1, CA2, and CA3 illustrated in FIGS. 7A to 7C. Note that, although not illustrated, information as to which portion is the summarized portion or the excerpted portion of each piece of the first distribution content is also output from the generative AI.

An output format of the generative AI can be in a JSON format, and an instruction to that effect can be included in the instruction sentence. Accordingly, processing for the output from the generative AI can be easily performed. For example, as the instruction sentence input into the generative AI, it is possible to use an instruction sentence that includes an instruction to cause the predetermined event content to be output in a first output format and to cause a combination of the first distribution content ID and the partial information (for example, the summarized portion or the excerpted portion) of the first distribution content to be output in a second output format.

The generation unit 31 updates the second distribution content table based on the information output in the first output format, and updates the above-described partial information table based on the information output in the second output format, but is not limited to such an example.

### 3.3.3. Distribution Unit 32

The distribution unit 32 distributes various types of information. The distribution unit 32 can distribute various types of information to the user U by, for example, transmitting the various types of information to the terminal device 2. The distribution unit 32 acquires, from the generation unit 31 or the content storage unit 21, the predetermined event content generated by the generation unit 31, partial information on each piece of the first distribution content, and the like. In addition, the distribution unit 32 acquires the advertisement content from the content storage unit 21. The distribution unit 32 generates the second distribution content based on the acquired information. Note that the second distribution content may be generated by the generation unit 31.

The second distribution content includes, for example, the predetermined event content generated by the generation unit 31, the respective links to the plurality of pieces of first distribution content, and the advertisement content. The distribution unit 32 distributes the second distribution content to the user U by transmitting the second distribution content including the predetermined event content generated by the generation unit 31, the respective links to the plurality of pieces of first distribution content, and the advertisement content to the terminal device 2 via the communication unit 10.

In the second distribution content, for example, a link (for example, a hyperlink) to a corresponding piece of first distribution content among the plurality of pieces of first distribution content is set for each piece of information (for example, summary information, excerpt information, or the like) of the plurality of pieces of first distribution content.

In addition, in the second distribution content, for example, a footnote (for example, a number) may be attached to the information (for example, the summary information, the excerpt information, or the like) of the first distribution content, the content of the footnote may be arranged below or beside the predetermined event content, and a link to the first distribution content may be attached to the content of the footnote.

The distribution unit 32 can include the advertisement content in the second distribution content. Such advertisement content is, for example, advertisement content related to the predetermined event content, but is not limited to such an example.

FIG. 9 is a diagram illustrating an example of the second distribution content distributed by the distribution unit 32 in the processing unit 12 of the information processing apparatus 1 according to the embodiment. In the example illustrated in FIG. 9, the second distribution content includes the predetermined event content CD1, the respective links to the plurality of pieces of first distribution content CA1, CA2, and CA3, advertisement content AD1, and a link AD1 of the advertisement content. The advertisement content included in the second distribution content is, for example, advertisement content related to the predetermined event content, but is not limited to such an example.

In the example illustrated in FIG. 9, the second distribution content is generated from a plurality of pieces of first distribution content which are pieces of news content each having “new electric vehicle A” as a predetermined object. In the second distribution content, “new electric vehicle A is announced” is a title, and pieces of summary information on each of the three pieces of first distribution content are included. In the example illustrated in FIG. 9, these pieces of summary information are illustrated in different manners from each other for convenience of description so that the position of each piece of summary information can be understood.

In the example illustrated in FIG. 9, the summary information on the first piece of first distribution content is “A driving range of 600 kilometers or more is achieved on a single charge, and technological innovation is drawing attention.”, and a link (for example, a hyperlink) to acquire the first piece of first distribution content is attached. The link includes a URL of a transition destination.

In addition, in the example illustrated in FIG. 9, the summary information on the second piece of first distribution content is “This vehicle can significantly reduce carbon dioxide emissions, and environmental benefits are emphasized.”, and a link (for example, a hyperlink) to acquire the second piece of second distribution content is attached.

In addition, in the example illustrated in FIG. 9, the summary information on the third piece of first distribution content is “Economically, competitive pricing may affect the market and encourage industry consolidation.”, and a link (for example, a hyperlink) to acquire the third piece of second distribution content is attached.

### 3.3.4. Determination Unit 33

The determination unit 33 makes various determinations. The determination unit 33 determines, for example, a consideration to be paid by the distributor P of each of the plurality of pieces of first distribution content, based on a result of a selection by the user U for the links included in the second distribution content distributed by the distribution unit 32.

For example, the determination unit 33 can set an amount according to the number of selections by the user U as the consideration to be paid by the distributor P who distributes the first distribution content of the selected link. The amount according to the number of selections by the user U is, for example, an amount proportional to the number of selections by the user U or an amount that increases stepwise as the number of selections by the user U increases.

In addition, the determination unit 33 can also determine the consideration to be paid to the distributor P of each of the plurality of pieces of first distribution content, based on a result of a selection by the user U for the advertisement content included in the second distribution content distributed by the distribution unit 32. For example, the determination unit 33 can determine, as the consideration to be paid to each distributor P, an amount obtained by equally dividing a part of the revenue from the distribution of the advertisement content. In addition, the information processing apparatus 1 can determine, as the consideration to be paid to each distributor P, an amount from a part of the revenue from the distribution of the advertisement content, in which the amount becomes a larger amount or a smaller amount as the number of selections by the user U increases.

### 3.3.5. Selection Unit 34

The selection unit 34 performs various selections. For example, the selection unit 34 selects, as the first distribution content, a piece of content corresponding to a link in which a selection result of a link included in predetermined event content, which is content related to a predetermined event or object generated by the generation unit 31, satisfies a predetermined condition.

The link satisfying the predetermined condition is, for example, a link whose number of selections is equal to or greater than a threshold value, a link whose selection rate (a selection ratio of the link with respect to the number of distributions of the second distribution content) is equal to or greater than a threshold value, a link whose average selection time (a time from when the second distribution content is distributed until the link is selected) is equal to or greater than a threshold value, or the like, but is not limited to such an example. For example, the link satisfying the predetermined condition may be a link satisfying two or more of the following conditions: the number of selections is equal to or greater than a threshold value, the selection rate is equal to or greater than a threshold value, and the average selection time is equal to or greater than a threshold value.

The predetermined condition may be, for example, a condition that is different for each category of the first distribution content (for example, a different threshold value), a condition that is different for each attribute of the user U, or a condition that is different for each combination of the category of the first distribution content and the attribute of the user U.

In addition, the link satisfying the predetermined condition may be, for example, a link to the first distribution content having a high selection probability of advertisement content. A case in which the selection probability of advertisement content is high is, for example, a case in which the selection probability of the advertisement content is equal to or greater than a threshold value. In addition, the first distribution content having a high selection probability of the advertisement content is the first distribution content in which a selection probability of the advertisement content included in the second distribution content including the summary information or the excerpt information is high.

With respect to a predetermined event or object, the selection unit 34 can perform, for example, the above-described selection based on the result after a plurality of pieces of second distribution content respectively generated by using a plurality of pieces of first distribution content of different combinations are distributed by the distribution unit 32 for a predetermined period.

### 4. Processing Procedure

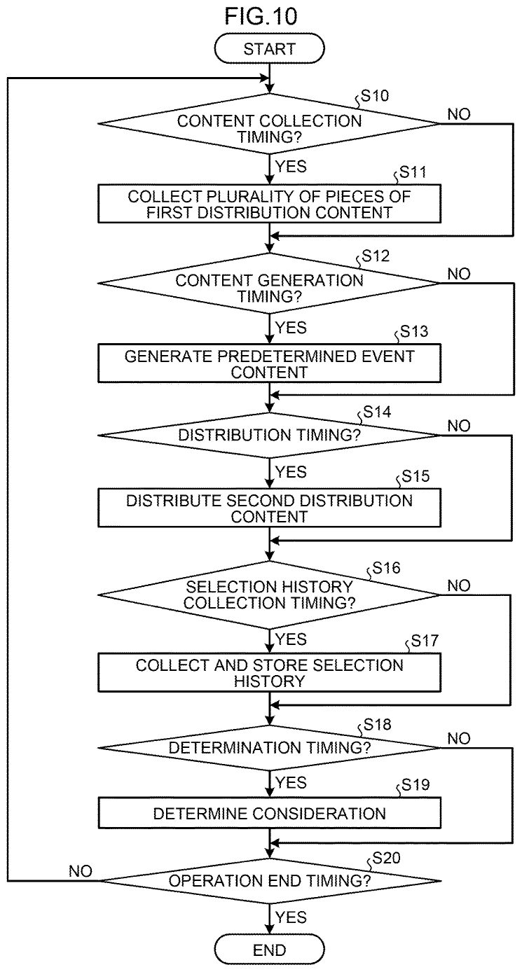

Next, a procedure of information processing by the processing unit 12 of the information processing apparatus 1 according to the embodiment will be described. FIG. 10 is a flowchart illustrating an example of information processing by the processing unit 12 of the information processing apparatus 1 according to the embodiment.

As illustrated in FIG. 10, the processing unit 12 determines whether a content collection timing has arrived (Step S10). The content collection timing is, for example, a timing that arrives in a predetermined cycle, or a timing instructed by an operator of the information processing apparatus 1, or the like, but is not limited to such an example.

Upon determining that the content collection timing has arrived (Step S10: Yes), the processing unit 12 collects a plurality of pieces of first distribution content related to a predetermined event or a predetermined object (Step S11).

When the processing of Step S11 is completed, or when it is determined that the content collection timing has not arrived (Step S10: No), the processing unit 12 determines whether a content generation timing has arrived (Step S12). The content generation timing is a timing that arrives in a predetermined cycle, or a timing instructed by an operator of the information processing apparatus 1, or the like, but is not limited to such an example.

Upon determining that the content generation timing has arrived (Step S12: Yes), the processing unit 12 generates predetermined event content (Step S13). Note that in Step S13, the processing unit 12 can also generate second distribution content including the predetermined event content. When the processing of Step S13 is completed, or when it is determined that the content generation timing has not arrived (Step S12: No), the processing unit 12 determines whether a content distribution timing has arrived (Step S14).

Upon determining that the content distribution timing has arrived (Step S14: Yes), the processing unit 12 distributes second distribution content (Step S15). The content distribution timing is, for example, a case in which there is a request from the user U, or a timing when a predetermined application program is started in the terminal device 2, or the like, but is not limited to such an example.

When the processing of Step S15 is completed, or when it is determined that the content distribution timing has not arrived (Step S14: No), the processing unit 12 determines whether a selection history collection timing has arrived (Step S16). The selection history collection timing is, for example, a timing when distribution of the second distribution content is completed, or a timing that arrives in a predetermined cycle (for example, a monthly timing), but is not limited to such an example.

Upon determining that the selection history collection timing has arrived (Step S16: Yes), the processing unit 12 collects a selection history and causes the storage unit 11 to store the collected selection history therein (Step S17). When the processing of Step S17 is completed, or when it is determined that the selection history collection timing has not arrived (Step S16: No), the processing unit 12 determines whether a determination timing has arrived (Step S18). The determination timing is, for example, a timing when distribution of the second distribution content is completed, or a timing that arrives in a predetermined cycle (for example, a monthly timing), but is not limited to such an example.

Upon determining that the determination timing has arrived (Step S18: Yes), the processing unit 12 determines a consideration to be paid by each distributor P and a consideration to be paid to each distributor P (Step S19). When the processing of Step S19 is completed, or when it is determined that the determination timing has not arrived (Step S18: No), the processing unit 12 determines whether an operation end timing has arrived (Step S20). For example, when the power of the information processing apparatus 1 is turned off, or when it is determined that an end operation has been performed by an operation on an operation unit (not illustrated) of the information processing apparatus 1, the processing unit 12 determines that the operation end timing has arrived.

Upon determining that the operation end timing has not arrived (Step S20: No), the processing unit 12 shifts the processing to Step S10, and upon determining that the operation end timing has arrived (Step S20: Yes), the processing unit 12 ends the processing illustrated in FIG. 10.

### 5. Modification

In the above-described example, different pieces of information obtained by extraction (for example, summary or excerpt) from different pieces of first distribution content are included in the predetermined event content, but the present invention is not limited to such an example.

For example, the predetermined event content may include information extracted from two or more pieces of first distribution content (hereinafter referred to as common information). In this case, the distribution unit 32 or the generation unit 31 can set, as a link to the common information, a link in which a link destination changes with a probability according to an extraction ratio. For example, for a link attached to common information extracted from the pieces of first distribution content CA1 and CA2, a link destination is switched between the first distribution content CA1 and the first distribution content CA2 with a probability according to an extraction ratio.

The extraction ratio can be obtained, for example, by instructing the generative AI to output the extraction ratio, but may be a fixed extraction ratio. The extraction ratio is indicated, for example, by a ratio of unit selection prices of links, but is not limited to such an example.

In addition, the extraction ratio can be a ratio according to an attribute of the user U, or can be a ratio according to a combination of a category of a predetermined event or object and the attribute of the user U.

Furthermore, the generation unit 31 can cause the generative AI to regenerate the predetermined event content included in the second distribution content in which the selection rate of the links is equal to or less than a threshold value, and the distribution unit 32 can distribute the second distribution content including the regenerated predetermined event content. In this case, for example, the generation unit 31 inputs the predetermined event content included in the second distribution content having a high selection rate of a link to the generative AI as reference information, thereby making it possible to increase a probability of generating the predetermined event content that can increase the selection rate of the link.

In addition, the generation unit 31 can cause the generative AI to generate the predetermined event content for each attribute of the user U, and the distribution unit 32 can distribute the second distribution content including the predetermined event content according to the attribute of the user U. In this case, by inputting the attribute information on the user U to the generative AI as the reference information, the generation unit 31 can increase a probability of generating the predetermined event content suitable for the user U.

In addition, the generation unit 31 can include, in the predetermined event content, extraction information in a different manner (for example, character color, font, character size, background color, character modification, or the like) for each piece of first distribution content so that it can be understood which piece of first distribution content the extraction information (for example, summary information or excerpt information) corresponds to.

Further, in a case of the first distribution content including the advertisement content, even in a case in which a relationship with the predetermined event or object is low, the generation unit 31 can generate the predetermined event content by using the first distribution content as the first distribution content related to the predetermined event or object.

In addition, the determination unit 33 can determine a consideration to be paid by the distributor P of the first distribution content including the advertisement content to be higher than a consideration to be paid by the distributor P of the first distribution content not including the advertisement content.

Additionally, in addition to a result of a selection by the user U for a link included in the second distribution content distributed by the distribution unit 32, the determination unit 33 can also determine a consideration to be paid by the distributor P of the first distribution content by further using a result of a conversion corresponding to the link. For example, the consideration to be paid by the distributor P can be determined based on the number of selections by the user U of a link and the number of conversions corresponding to the link.

In the above-described example, an example in which the generation unit 31 generates a summary from the text of the content has been described, but in a case in which an image and text are included in the content, the generation unit 31 can also generate a summary from the image and the text by using a generative LLM. In addition, the generation unit 31 can also generate an image suitable for the predetermined event content by using an image generative AI.

### 6. Hardware Configuration

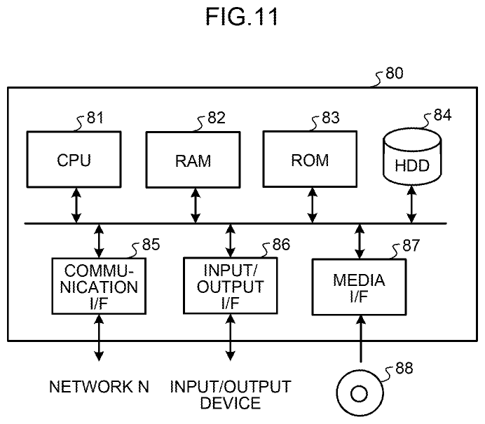

The information processing apparatus 1 according to the above-described embodiment is implemented, for example, by a computer 80 having a configuration as illustrated in FIG. 11. FIG. 11 is a hardware configuration diagram illustrating an example of the computer 80 that implements a function of the information processing apparatus 1 according to the embodiment. The computer 80 includes a CPU 81, a RAM 82, a Read Only Memory (ROM) 83, a Hard Disk Drive (HDD) 84, a communication interface (I/F) 85, an input/output interface (I/F) 86, and a media interface (I/F) 87.

The CPU 81 operates based on a program stored in the ROM 83 or the HDD 84, and controls each unit. The ROM 83 stores a boot program executed by the CPU 81 when the computer 80 is started, a program depending on the hardware of the computer 80, and the like.

The HDD 84 stores a program executed by the CPU 81, data used by the program, and the like. The communication interface 85 receives data from another device via the network N (refer to FIG. 2) and sends the data to the CPU 81, and transmits data generated by the CPU 81 to another device via the network N.

The CPU 81 controls an output device such as a display and a printer, and an input device such as a keyboard or a mouse via the input/output interface 86. The CPU 81 acquires data from the input device via the input/output interface 86. In addition, the CPU 81 outputs the generated data to the output device via the input/output interface 86.

The media interface 87 reads a program or data stored in a recording medium 88 and provides the program or the data to the CPU 81 via the RAM 82. The CPU 81 loads the program from the recording medium 88 onto the RAM 82 via the media interface 87, and executes the loaded program. The recording medium 88 is, for example, an optical recording medium such as a Digital Versatile Disc (DVD) or a Phase change rewritable Disk (PD), a magneto-optical recording medium such as a Magneto-Optical disk (MO), a tape medium, a magnetic recording medium, or a semiconductor memory.

For example, when the computer 80 functions as the information processing apparatus 1 according to the embodiment, the CPU 81 of the computer 80 implements the function of the processing unit 12 by executing a program loaded on the RAM 82. In addition, the data in the storage unit 11 is stored in the HDD 84. The CPU 81 of the computer 80 reads and executes these programs from the recording medium 88, but as another example, the CPU 81 may acquire these programs from another device via the network N.

### 7. Others

In addition, among the processes described in the above embodiment, all or a part of the processes described as being automatically performed can be manually performed, or all or a part of the processes described as being manually performed can be automatically performed by a known method. In addition, the processing procedure, specific name, and information including various types of data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit according to various loads, usage conditions, and the like.

For example, the above-described information processing apparatus 1 may be implemented by a terminal device and a server computer, may be implemented by a plurality of server computers, or may be implemented by calling an external platform or the like with an API, network computing, or the like depending on functions, so that the configuration can be flexibly changed.

In addition, the above-described embodiments and modifications can be appropriately combined within a range in which processing contents do not contradict each other.

### 8. Effects

As described above, the information processing apparatus 1 according to the embodiment includes the collection unit 30, the generation unit 31, the distribution unit 32, and the determination unit 33. The collection unit 30 collects a plurality of pieces of first distribution content each including content related to a predetermined event or object. The generation unit 31 generates the content related to the predetermined event or object based on the plurality of pieces of first distribution content collected by the collection unit 30. The distribution unit 32 distributes, to the user U, second distribution content including the content generated by the generation unit 31 and respective links to the plurality of pieces of first distribution content. The determination unit 33 determines a consideration to be paid by the distributor P of each of the plurality of pieces of first distribution content, based on a result of a selection by the user U for a link included in the second distribution content distributed by the distribution unit 32. Accordingly, the information processing apparatus 1 can improve convenience of the user U. In addition, the information processing apparatus 1 can determine the consideration to be paid by the distributor P based on a result of guiding the user U to the first distribution content.

In addition, the generation unit 31 generates content related to a predetermined event or object by using the generative AI. Accordingly, the information processing apparatus 1 can accurately generate the content related to the predetermined event or object.

In addition, the generation unit 31 generates, by using the generative AI, content including information on each of the plurality of pieces of first distribution content as the content related to the predetermined event or object, and in the second distribution content, a link to a corresponding piece of first distribution content among the plurality of pieces of first distribution content is set for each piece of information on the plurality of pieces of first distribution content. Accordingly, the information processing apparatus 1 can accurately generate the second distribution content that can guide the user U to the first distribution content.

In addition, the first distribution content includes a news article related to a predetermined event or object. Accordingly, the information processing apparatus 1 can accurately generate the second distribution content that can guide the user U to the news article.

In addition, the second distribution content includes a link to advertisement content, and the determination unit 33 determines a consideration to be paid to the distributor P of each of the plurality of pieces of first distribution content, based on a result of a selection by the user U for the advertisement content included in the second distribution content distributed by the distribution unit 32. Accordingly, the information processing apparatus 1 can pay a consideration for use of the first distribution content, such as in a case in which there is no guiding of the user U to the first distribution content.

In addition, the information processing apparatus 1 according to the embodiment includes the selection unit 34 that selects, as the first distribution content, a piece of content corresponding to a link in which a selection result of the link included in the content related to a predetermined event or object generated by the generation unit 31 satisfies a predetermined condition. Accordingly, the information processing apparatus 1 can generate the second distribution content by using the appropriate first distribution content.

Although the embodiment of the present application has been described in detail with reference to the drawings, this is merely an example, and the present invention can be implemented in other forms in which various modifications and improvements are made based on the knowledge of those skilled in the art, including the aspects described in the section of disclosure of the invention.

In addition, the above-described “unit (section, module, unit)” can be read as “means”, “circuit”, or the like. For example, the acquisition unit can be read as an acquisition means or an acquisition circuit.

What is claimed is:

1. An information processing apparatus comprising:
a collection unit configured to collect a plurality of pieces of first distribution content each including content related to a predetermined event or object;
a generation unit configured to, based on the plurality of pieces of first distribution content collected by the collection unit, generate the content related to the predetermined event or object;
a distribution unit configured to distribute, to a user, second distribution content including the content generated by the generation unit and respective links to the plurality of pieces of first distribution content; and
a determination unit configured to, based on a result of a selection by the user for the links included in the second distribution content distributed by the distribution unit, determine a consideration to be paid by a distributor of each of the plurality of pieces of first distribution content.

2. The information processing apparatus according to claim 1, wherein
the generation unit is configured to generate, by using a generative AI, the content related to the predetermined event or object.

3. The information processing apparatus according to claim 2, wherein
the generation unit is configured to generate, by using the generative AI, content including information on each of the plurality of pieces of first distribution content as the content related to the predetermined event or object, and
in the second distribution content, the link to a corresponding piece of first distribution content among the plurality of pieces of first distribution content is set for each piece of information on the plurality of pieces of first distribution content.

4. The information processing apparatus according to claim 1, wherein
the first distribution content includes a news article related to the predetermined event or object.

5. The information processing apparatus according to claim 1, wherein
the second distribution content includes a link to advertisement content, and
the determination unit is configured to, based on a result of a selection by the user for the advertisement content included in the second distribution content distributed by the distribution unit, determine a consideration to be paid to a distributor of each of the plurality of pieces of first distribution content.

6. The information processing apparatus according to claim 1, comprising
a selection unit configured to select, as the first distribution content, a piece of content corresponding to a link in which a selection result of the link included in the content related to the predetermined event or object generated by the generation unit satisfies a predetermined condition.

7. An information processing method executed by a computer, the method comprising:
collecting a plurality of pieces of first distribution content each including content related to a predetermined event or object;
generating, based on the plurality of pieces of first distribution content, the content related to the predetermined event or object;
distributing, to a user, second distribution content including the content related to the predetermined event or object and respective links to the plurality of pieces of first distribution content; and
determining, based on a result of a selection by the user for the links included in the second distribution content, a consideration to be paid by a distributor of each of the plurality of pieces of first distribution content.

8. A non-transitory computer readable storage medium storing therein an information processing program for causing a computer to execute processing comprising:
collecting a plurality of pieces of first distribution content each including content related to a predetermined event or object;
generating, based on the plurality of pieces of first distribution content, the content related to the predetermined event or object;
distributing, to a user, second distribution content including the content related to the predetermined event or object and respective links to the plurality of pieces of first distribution content; and
determining, based on a result of a selection by the user for the links included in the second distribution content, a consideration to be paid by a distributor of each of the plurality of pieces of first distribution content.
